(19) United States
(12) Patent Application Publication
(10) Pub. No.: US 2005/0019511 A1
(43) Pub. Date: Jan. 27, 2005

(54) Barrier materials and containers made therefrom

(76) Inventors: Robert B. Piemonte, Bridgewater, MA (US); Richard C. Cox, E. Falmouth, MA (US); James S. Holicker, Foxboro, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/877,316

(22) Filed: Jun. 25, 2004

Related U.S. Application Data
(60) Provisional application No. 60/482,415, filed on Jun. 25, 2003.

(51) Int. Cl. F16L 1/00

(52) U.S. Cl. 428/34.1

(57) ABSTRACT

A barrier structure comprises: a first membrane substantially reflective of electromagnetic radiation; a second membrane spaced apart from the first membrane and bound to the first membrane about an edge thereof to form a bladder, the second membrane resistant to vapor transmission; and a fibrous insert disposed between the first membrane and the second membrane so as to maintain the spaced apart relationship, the fibrous insert defining a space holding an insulating medium resistant to the transmission of thermal energy and interspersed therethough. The first membrane may further comprise a multilayer composite and may include a polymer resistant to vapor transmission, for example including at least one of H₂O, CO₂ and O₂. The polymer may be a polyester. The multilayer composite may further comprise a structure substantially reflective of thermal energy. The composite may further comprise one or both of an outer metallization layer and an inner metallization layer. The composite may further comprise a sealing member. The sealing member may be a polyethylene layer. The fibrous insert may comprise randomly oriented fibers of plural deniers bonded together in a crush-resistant structure. The plural deniers may be within a range of 3 to 100 denier. The fibrous insert may further comprise an acrylic binder, an EVCL binder, a polyvinyl acetate (PVA) binder or other polymer binder and combinations thereof. The EVCL binder may be included in the fibrous insert as a percentage of material comprising the fibrous insert of about 35-75% w/w. The first membrane, the second membrane and the fibrous insert may all possess substantially similar melt flow indices. Also shown, a shipping container may comprise plural wall structures according to the thermal barrier structure described, disposed on at least two sides of a payload region, such as a box or envelope. The plural wall structures may be bonded together along at least one edge, for example to form a shipping envelope having an interior payload region surrounded by the bladders of the plural wall structures. The plural structures may further comprise a third membrane resistant to vapor transmission; and another fibrous insert disposed between the second membrane and the third membrane.

### RELATED APPLICATIONS

This application claims priority under 35 U.S.C. § 119(e) to U.S. Provisional Application Ser. No. 60/482,415, entitled “THERMAL INSULATION CONTAINER,” filed on Jun. 25, 2003, which is herein incorporated by reference in its entirety.

### BACKGROUND

The present invention relates to electromagnetic radiation barrier materials, particularly thermal barrier insulation materials, especially including thermal barrier insulation materials incorporated in or formed into shipping containers, including envelopes, bags, boxes, cases and the like.

Insulating packaging and materials, especially thermally insulating packaging and materials find many uses in storing and transporting sensitive payloads. Sensitive payloads may include pharmaceuticals, medical products such as blood products, food products and others that are preferably stored and shipped at temperatures below the usual ambient temperature.

An example of the use of thermally insulating materials is in a so-called “cold chain” of transportation. A pharmaceutical product might be prepared under chilled conditions or chilled after preparation in order to maintain certain desired properties. The pharmaceutical then needs to be shipped to an end user. In order to control costs, the shipping preferably takes place through conventional channels such as ordinary truck or air freight systems, which generally have little or no temperature control provisions for the payloads shipped. In order to preserve the pharmaceutical product for effective use by the end user, the manufacturer might place the pharmaceutical as a payload in a “cold chain” shipping container, which is then shipped conventionally by a next day freight or courier service.

Conventional “cold chain” shipping containers include multiple layers of insulating, conducting and reflecting layers that combine to allow a chilled payload to remain below a threshold temperature for the duration of shipping the payload. The ability of conventional systems to maintain the desired temperature is enhanced by including with the payload a cold sink that absorbs some of the heat energy that penetrates the shipping container, such as a block of dry ice, a cold gel pack, ice or the like.

Conventional shipping containers maintain proper cold temperatures for longer than up to about 24 hours. They do so using metal foils or unmetallized films that partly reflect thermal energy and partly absorb thermal energy, spreading it over the surface of the container, combined with various paper and plastic substrates and EPS, foam or masticated paper insulating layers. Also used are bubble wrap materials combined with foils.

The foam and masticated paper insulating layers are only partially effective due to excessive conduction of heat energy and due to absorption of moisture. Once a foam or masticated paper layer begins to absorb moisture, it conducts heat energy through that moisture ever more readily. Moreover, they provide little or no mechanical protection for the payload due to their density.

### SUMMARY OF INVENTION

What are desired are barrier materials, packaging materials and packages made therefrom that maintain the freshness of a payload protected thereby or carried therein, extends the shelf life of the payload, reduces growth of bacteria, retards decay or decomposition of the payload, prevents melting or shrinking of payloads susceptible to such, and maintains the flavor and/or aroma of certain payloads. Barrier materials and packaging made therefrom according to various aspects of the invention may provide one or more of these advantages, or other advantages as will be apparent to the skilled artisan upon reading the following Summary of Invention, as well as reading the following Detailed Description together with the Drawings.

According to aspects of embodiments of the invention, a barrier structure comprises: a first membrane substantially reflective of electromagnetic radiation; a second membrane spaced apart from the first membrane and bound to the first membrane about an edge thereof to form a bladder, the second membrane resistant to vapor transmission; and a fibrous insert disposed between the first membrane and the second membrane so as to maintain the spaced apart relationship, the fibrous insert defining a space holding an insulating medium resistant to the transmission of thermal energy and interspersed therethough. The first membrane may further comprise a multilayer composite and may include a polymer resistant to vapor transmission, for example including at least one of H₂O, CO₂ and O₂. The polymer may be a polyester. The multilayer composite may further comprise a structure substantially reflective of thermal energy. The composite may further comprise one or both of an outer metallization layer and an inner metallization layer. The composite may further comprise a sealing member. The sealing member may be a polyethylene layer. The fibrous insert may comprise randomly oriented fibers of plural deniers bonded together in a crush-resistant structure. The plural deniers may be within a range of 3 to 100 denier. The fibrous insert may further comprise an acrylic binder, an EVCL binder, a polyvinyl acetate (PVA) binder or other polymer binder and combinations thereof. The EVCL binder may be included in the fibrous insert as a percentage of material comprising the fibrous insert of about 35-75% w/w. The first membrane, the second membrane and the fibrous insert may all possess substantially similar melt flow indices.

According to other aspects of embodiments of the invention, a shipping container may comprise plural wall structures according to the thermal barrier structure described, disposed on at least two sides of a payload region, such as a box or envelope. The plural wall structures may be bonded together along at least one edge, for example to form a shipping envelope having an interior payload region surrounded by the bladders of the plural wall structures. The plural structures may further comprise a third membrane resistant to vapor transmission; and another fibrous insert disposed between the second membrane and the third membrane.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a cross-section view of the three main components of a barrier material according to aspects of an embodiment of the invention;

FIG. 2 is a cross-section view of the components of FIG. 1, assembled into a barrier bladder with side seams;

FIG. 3 is a cross-section top view of a shipping envelope constructed of two barrier bladders as shown in FIG. 2;

FIG. 4 is a plan view of the top edge of the shipping envelope of FIG. 3, showing some closure details;

FIG. 5 is a cross-section side view of the shipping envelope of FIG. 4 showing further closure details; and

FIG. 6 is a perspective view of a shipping container including barrier material in the walls according to aspects of an embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Aspects of embodiments of the present invention provide a low cost, effective, light-weight structure for protecting and/or insulating a payload, particularly for thermally insulating temperature sensitive payloads for an extended period of time. Comparisons under matched conditions of conventional shipping containers and containers according to aspect of embodiments of the invention have show conventional containers to maintain proper temperatures for up to about 24 hours, whereas our containers can maintain proper temperatures for example, but not limited to, a period of 24-48 hrs. Aspects of embodiments of the present invention also provide a cushioned, aseptic, tamper resistant package. Other aspects of embodiments of the invention also provide for prevention of freezing when the package is exposed to sub-freezing temperatures.

The barrier material according to some aspects of embodiments of the present invention is a bladder comprised of three main elements, as shown in the cross-section of FIG. 1.

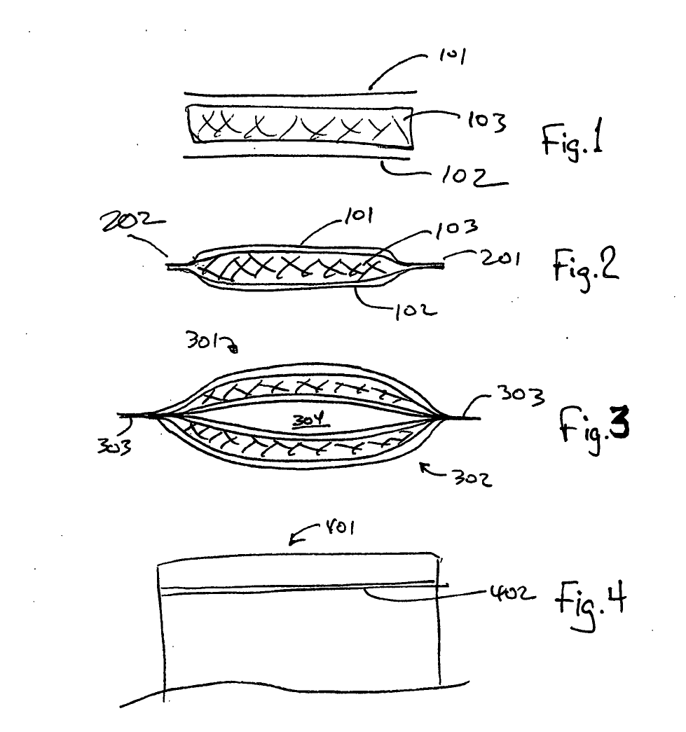

The three elements comprising the bladder are an electromagnetic radiation reflecting layer 101, a vapor barrier 102 and a fibrous insert 103. As shown in the cross-section of FIG. 2, the three elements are sealed at the edges 201 and 202. Each barrier wall structure according to some aspects of embodiments of the invention is sealed at the edges around the entire periphery of the bladder comprising the barrier wall. The bladder can have any suitable shape when viewed in plan view. For example, the bladder may be circular to cover the bottom of a cylindrical container, or may be rectangular when used as one wall of a shipping envelope.

Now, the three main elements of the bladder of FIGS. 1 and 2 are described in more detail. First, the reflecting layer 101 is described, followed by the vapor barrier 102 and the fibrous insert 103.

The reflecting layer 101 is itself a multi-layered composite material according to aspects of some embodiments of the invention. The composite may have a polymer substrate, for example polyethylene teraphthalate (PET). Any suitable substrate may be used, although some preferable properties of the substrate material include vacuum formability, low porosity and low vapor transmission relative to oxygen (O₂), water (H₂O) and carbon dioxide (CO₂), high burst strength, puncture resistance, flexibility, environmental compatibility for disposal or recycling and compatibility with the other materials to be used for purposes of sealing the edges. The sealing method to be described below includes use of heat and pressure to form bonded edge seals. Therefore, compatibility with the other materials to be used for purposes of sealing the edges can include material compatibility and melt flow index compatibility between the substrate of the reflecting layer 101, the other components of the reflecting layer composite, the vapor barrier layer 102 and the fibrous insert 103.

To provide the reflecting layer 101 with suitable reflecting qualities, it includes one or more metallization layers. For example, a polymer substrate having two layers of aluminum (Al) metallization of about 280 Å thickness each reflects about 97% of light from ultraviolet (UV) through infrared (IR) at the first layer, with much of the balance (only 3%) reflected at the second layer. Other thicknesses of metallization may be suitable to achieve other results as may be desired. A greater thickness of Al may result in greater than 97% reflectivity at the first metallization layer, for example. The level of performance described would be suitable for many pharmaceutical products, foods and other medical products that could be damaged by UV radiation or excessive heat or cold. Other suitable metallization layers include copper (Cu) and other suitable metals. Different metallization layers provide different reflective characteristics. A metallization material may be chosen to provide any suitable reflective characteristic.

The composite may have a layer provided to aid in sealing the edges of the bladder, for example a layer of another polymer. Providing such an additional layer may permit the use of materials in the vapor barrier 102 and the fibrous insert 103 that would be otherwise incompatible for sealing purposes with the substrate material of the reflecting layer 101, for example PET.

The vapor barrier layer should resist transmission of O₂, H₂O and CO₂, or any other vapor desired to be blocked. The vapor barrier layer 102 can be simply a layer of any suitable polymer. The vapor barrier should also be environmentally compatible for disposal, as well as suitable for placement adjacent the payload when used in packaging. For example, for foodstuff payloads, the vapor barrier should be an FDA-approved, food storage and shipment material. As with the reflecting layer 101, the vapor barrier layer 102 should be compatible for heat sealing with the other components of the barrier material.

One suitable material for the vapor barrier is polyethylene sheeting. Polyethylene sheeting possesses all of the characteristics discussed above. It also remains flexible at low temperatures, and is resistant to many chemical and biological materials that are desired to be shipped as payloads in containers made using aspects of embodiments of the invention.

The fibrous insert layer 103 helps maintain the air pocket in the bladder by supporting the reflective layer 101 and the vapor barrier layer 102 away from each other, as well as providing some mechanical protection for the payload of a container made using aspects of embodiments of the invention. Thus, the fibrous insert layer 103 should be crush resistant,under repeated crush insult or if vapor or payload material should penetrate a breached vapor barrier layer 102, contain a large volume of air or other suitable insulating medium and should be compatible for heat sealing with the other components of the barrier material. The fibrous insert layer 103 should further be non-absorbent and resistant to decomposition due to biologic action. Also, as with the other materials used, the fibrous insert layer 103 should be environmentally compatible for disposal.

Materials and structures suitable for the fibrous insert layer 103 are now described.

Preferably, the fibrous insert layer 103 is a batting or non-woven matrix of PET fibers having multiple deniers. Deniers in a range of about 3 to 100 are suitable, with a mixture of fibers having deniers of 3, 6, 15, 25 and 45 having been found to be particularly suitable. The mixture of fibers from which the fibrous insert layer 103 is formed are further mixed with about 35% to 75% w/w of a binder to retain the fibers in the form of a batting or non-woven matrix. Suitable binders include 38% to 48% w/w of ethylene vinyl chloride (EVCL), an acrylic or a PVA. The binder should possess similar environmental compatibility and sealing properties to the other materials, or at least not interfere with those properties.

As mentioned above, each bladder wall is sealed at the edges (see FIG. 2, 201 and 202). Conventional heat and pressure sealing techniques can be used, if the materials selected all have similar melt flow indices. As is known in the art, sealing processes operate successfully over ranges of temperatures and pressures. According to some aspects of some embodiments of the invention, the sealing temperature and pressure should be selected or adjusted so as to provide a well-bonded but porous seal. The degree of porosity can be adjusted, for example, by adjusting the pressure or dwell time, while holding the sealing temperature at a level to provide a well-bonded seal. By allowing the seam to be porous, the bladder can adjust to changes in external pressure without bursting. For example, if the external pressure on a bladder incorporated into a shipping container drops due to the container being carried at high altitude by an aircraft, the internal pressure of the bladder bleeds out through the seam. However, when the package returns to a higher pressure zone, such as ground level, air can bleed back in through the seam. The bladder volume is maintained by the fibrous insert 103, so the bladder becomes a low pressure zone, and the pressure differential between ambient and the interior of the bladder, across the seam, results in the bleeding back in of some air. Thus, the insulating properties of a bladder having relatively still air inside are maintained over a range of pressures, without the need for a valve and without concern for bursting of the bladder.

A sealed seam has been described for the circumstance in which adjustment to external pressure changes is required. Alternatively, if adjustment to external pressure changes is not a requirement, then the seam can be formed between only the reflective layer 101 and the vapor barrier layer 103 with the batting having a size small enough that it does not extend into the seam. This construction has at least an advantage of lower manufacturing cost.

Barrier material as described above can be supplied in many forms.

One form in which the barrier material can be provided, is pre-assembled into a shipping envelope, as shown in FIGS. 3, 4 and 5.

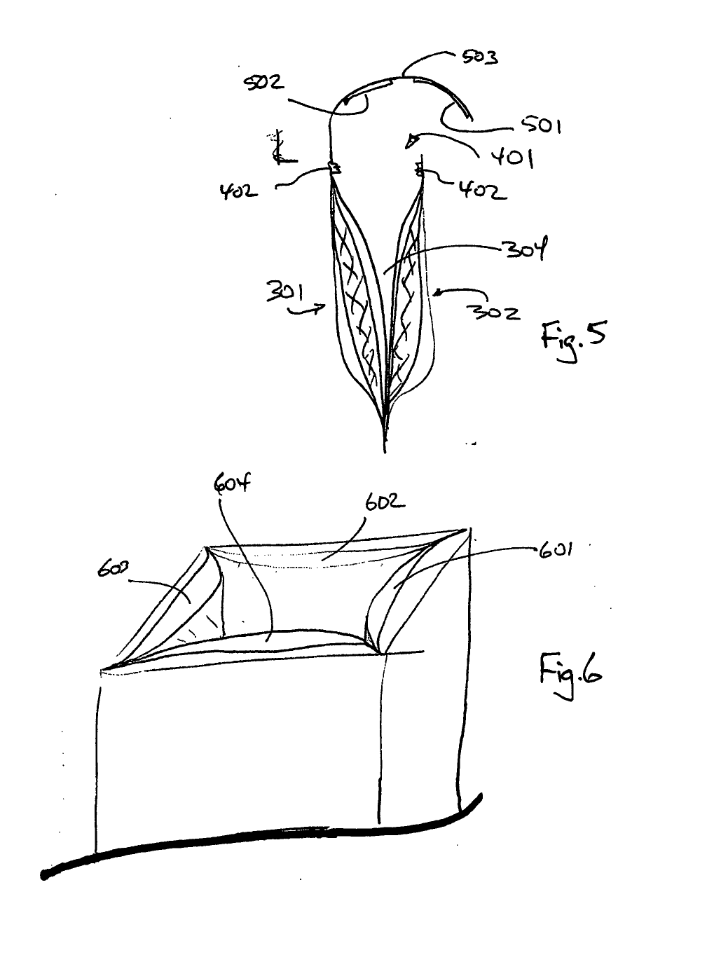

A shipping envelope according to aspects of embodiments of the invention includes two walls (FIG. 3, 301 and 302), each formed of the barrier material described above. Each wall (FIG. 3, 301 and 302) includes the three layers described above, a reflecting layer 101, a vapor barrier layer 102 and a fibrous insert 103. The edges of the shipping envelope are sealed as described above to form a six-layer seam (FIG. 3, 303) around the periphery of the envelope, leaving one edge open (FIGS. 4 and 5, 401) to receive the payload into an interior space (FIGS. 3 and 5, 304).

The open edge (FIGS. 4 and 5, 401) may be sealed after loading the payload into the envelope, for example using a plastic zipper-type seal (FIGS. 4 and 5, 402) and/or a tape seal (FIG. 5, 501 and 502). Prior to use, each tape seal (FIG. 5, 501 and 502) is covered by a release paper strip (not shown) that is removed in order to make the seal.

Tape seals are useful for providing a more secure closure and for providing a tamper-evident closure. In order to provide some degree of re-usability to the shipping envelope, two tape seals (FIG. 5, 501 and 502) are shown. The space between them can be perforated or otherwise weakened (FIG. 5, 503) for permitting the opening of the envelope sealed using the first tape seal (FIG. 5, 501), which can then be resealed using the second tape seal (FIG. 5, 502). Thus, a payload can be shipped from a supplier to a consumer, operated upon by that consumer and finally shipped back to the supplier, as is sometimes done in pharmaceutical and medical testing scenarios.

Another form in which the barrier material can be supplied is as rolls of sheet material, or as individual bladder walls, i.e. pre-divided and pre-sealed sheets of material.

For example, rolls of material, sealed along the side edges can be supplied with or without cross seals. A roll of material with cross seals is, of course, pre-divided into sheets, each sheet being one bladder. The cross seals can be provided with perforations, for example, to allow each bladder to be separated from the roll and placed in a shipping container as an insulating wall. Without cross seals, the user would need sealing equipment to seal and separate bladders of arbitrary desired dimensions from the roll.

Sheets of material, i.e., individual bladders, can be inserted into suitable shipping boxes arranged and sized to receive them, as shown in FIG. 6. Each bladder 601, 602, 603 and 604 is particularly sized to fit the wall of the box into which it is inserted. In a conventional, six-sided box, six closely-fitting wall bladders would be employed. The shipping container could also be substantially cylindrical, in which case a floor bladder, a ceiling bladder and a single, wrap-around wall bladder could be inserted.

Many variations to the foregoing are possible. Although the invention has been illustrated with respect to keeping a payload cold, the invention can also be used to keep a payload hot or any other desired temperature. Aspects of the embodiments of the invention illustrated also possess other useful properties. For example, the shipping envelope or shipping container, having a metallization layer substantially completely surrounding the payload, forms a Faraday cage protecting the payload from electrical shock. The barrier material itself has superior mechanical shock absorbing properties, and so could be used to protect fragile payloads, or as a cushion or pad to protect a payload, even when insulation properties are not required. In the shipping envelope described in connection with FIGS. 3, 4, and/or 5, each wall 301 and 302 may include two layers of barrier material. In any of the shipping containers or other uses of the barrier material, the reflective layer may be the exterior layer or an interior layer. This choice will usually, although not exclusively, depend on which side of the barrier will be exposed to heat and which to cold. Preferably, the reflective layer faces the heat source.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A barrier structure, comprising:
a first membrane substantially reflective of electromagnetic radiation;
a second membrane spaced apart from the first membrane and bound to the first membrane about an edge thereof to form a bladder, the second membrane resistant to vapor transmission; and
a fibrous insert disposed between the first membrane and the second membrane so as to maintain the spaced apart relationship, the fibrous insert defining a still air space resistant to the transmission of electromagnetic radiation and interspersed therethough.

2. The structure of claim 1, wherein the first membrane further comprises:
a multilayer composite.

3. The structure of claim 2, wherein the composite includes a polymer resistant to vapor transmission.

4. The structure of claim 3, wherein the vapor whose transmission the polymer resists includes at least one of H₂O, CO₂ and O₂.

5. The structure of claim 4, wherein the polymer is a polyester.

6. The structure of claim 2, wherein the multilayer composite further comprises:
a structure substantially reflective of thermal energy.

7. The structure of claim 6, wherein the composite further comprises:
one of an outer metallization layer and an inner metallization layer.

8. The structure of claim 7, wherein the composite further comprises:
another one of an outer metallization layer and an inner metallization layer.

9. The structure of claim 8, wherein the composite further comprises:
a sealing member.

10. The structure of claim 9, wherein the sealing member further comprises:
a polyethylene layer.

11. The structure of claim 10, wherein the fibrous insert comprises:
randomly oriented fibers of plural deniers bonded together in a crush-resistant structure.

12. The structure of claim 11, wherein the plural deniers are within a range of 3 to 100 denier.

13. The structure of claim 12, wherein the fibrous insert further comprises:
at least one of an EVCL binder, an acrylic binder and a PVA binder.

14. The structure of claim 13, wherein the fibrous insert further comprises:
an EVCL binder.

15. The structure of claim 14, wherein the EVCL binder is included in the fibrous insert as a percentage of material comprising the fibrous insert of about 35-75% w/w.

16. The structure of claim 1, wherein the first membrane, the second membrane and the fibrous insert all possess substantially similar melt flow indices.

17. A shipping container comprising:
plural wall structures according to the thermal barrier structure of claim 1, disposed on at least two sides of a payload region.

18. The shipping container according to claim 17, wherein the plural wall structures are bonded together along at least one edge.

19. The shipping container according to claim 18, wherein the plural structures are bonded together to form a shipping envelope having an interior payload region surrounded by the bladders of the plural wall structures.

20. The shipping container according to claim 19, wherein each of the plural structures further comprises:
a third membrane resistant to vapor transmission; and
another fibrous insert disposed between the second membrane and the third membrane.

21. The shipping container according to claim 17 wherein the plural structures are incorporated in walls of a box structure.

22. The structure of claim 17, wherein the one of the outer metallization layer and the inner metallization layer is capable of receiving a static electric discharge to the structure without damage to items carried therein.
